(19) United States
(12) Patent Application Publication
(10) Pub. No.: US 2024/0088437 A1
(43) Pub. Date: Mar. 14, 2024

(54) LINEAR SUPERIONIC POLYMER ELECTROLYTE

(71) Applicant: Ionic Materials, Inc., Woburn, MA (US)

(72) Inventors: Andrew Paul Leitner, Lynn, MA (US); Morgan Elliot Taylor, Melrose, MA (US); Alexander Ali Ibrahim Mohamed, Stoneham, MA (US)

(73) Assignee: Ionic Materials, Inc., Woburn, MA (US)

(21) Appl. No.: 18/238,116

(22) Filed: Aug. 25, 2023

Related U.S. Application Data
(60) Provisional application No. 63/401,276, filed on Aug. 26, 2022.

(51) Int. Cl. H01M 10/0565

(52) U.S. Cl. CPC H01M 10/0565; H01M 2300/0082

(57) ABSTRACT

A polymer electrolyte is disclosed that includes a polymer backbone containing a high dipole moiety and a low T_{g} moiety and a salt combined with the polymer. In addition to other possible benefits, the high dipole moiety in the polymer backbone may improve the conductivity of the polymer electrolyte. Additionally, the combination of a moiety with a high dipole moment with a moiety to impart low T_{g} may result in a high dielectric constant (for example, greater than 10).

### CROSS-REFERENCE TO RELATED APPLICATIONS

This application claims priority to U.S. Provisional Patent Application No. 63/401,276, filed Aug. 26, 2022, the entire contents of which are incorporated by reference herein.

### BACKGROUND

Salts are used to carry the charge in an electrolyte of an electrochemical cell when being charged or discharged. Small molecule solvents (<150 g/mol) are conventionally used in batteries to dissolve salts and transport the charge. These small molecule solvents can also take place in redox reactions at the electrode and lead to a reduction in efficiency of the electrochemical cell and a reduction in cycle life over time. Small molecule solvents also typically have a high vapor pressure and high flammability leading to safety issues. Large molecule solvents (>5000 g/mol) would address many of these concerns. For example, large molecule solvents would prevent a continuous reaction at the interface of the electrode because the larger molecular weight would diffuse much less, leading the improved cycle life and efficiency of the electrochemical cell. Because of the large molecular weight, the vapor pressure may also be significantly less, resulting in improved safety.

### SUMMARY

A high dielectric material is helpful to achieving 100% or approximately 100% dissociation of the salts present in an electrochemical cell. Polymer materials with high dielectric constant (>10) are hard to come by because the combination of properties (containing a high dipole component and having high molecular mobility) are sometimes directly contrasting.

A polymer electrolyte is disclosed that includes a polymer backbone that contains a high dipole moiety and a low T_{g} moiety. The polymer electrolyte also includes a salt combined with the polymer.

In some prior devices, high dipole molecules were added to low T_{g} polymers like PEO and PDMS via side chains and multi-block copolymers. However, unlike embodiments of the prior art, the presently disclosed polymer electrolyte combines a superionic conductivity mechanism, where the high dipole moiety is in the backbone of the polymer, along with high dielectric constant polymers. The disclosed polymers do not require the aid of solvents to dissociate salts (e.g., lithium salts) and do not require solvents for processing.

In the disclosed polymer electrolytes, the high dipole moiety may be selected from one or more of the following: an allyl carbonate, diallyl carbonate, poly(diallyldimethylammonium) bis(trifluoromethanesulfonyl)imide (PDADMA TFSI), a quaternary ammonium salt, an organocarbonate, dimethyl carbonate, ethylene carbonate, polypropylene carbonate, and combinations thereof. In some embodiments, the high dipole moiety is selected from one or more of the following polymers:

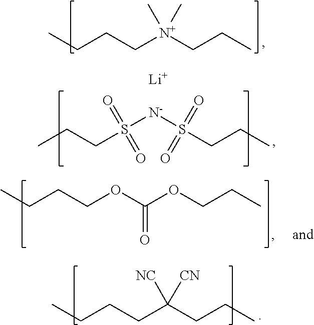

In these and other embodiments, the low T_{g} moiety may be selected from one or more of the following: a thiol, 1,4-butanedithiol, 2,2′(Ethylenedioxy)diethanethiol, and combinations thereof. In select embodiments, the low T_{g} moiety may be selected from one or more of the following polymers:

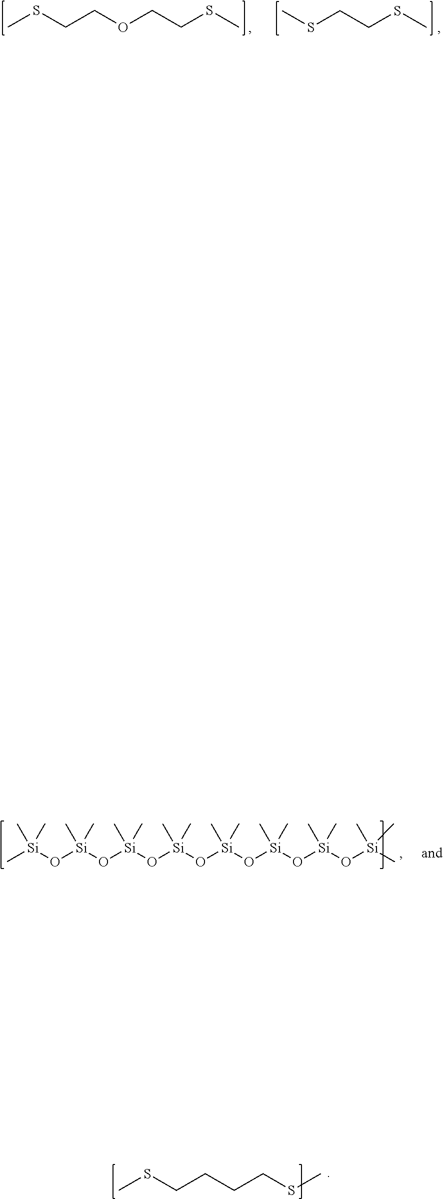

In some embodiments, the low T_{g} moiety may have a T_{g} of less than 120° C. In these and other embodiments, the polymer backbone may have a molar ratio of the high dipole moiety and the low T_{g} moiety of between 0.4 and 0.10. The polymer backbone may have a molecular weight of greater than 5000 g/mol. In select embodiments, the salt combined with the polymer may be a lithium salt, such as lithium hexafluorophosphate (LiPF₆), LiClO₄, LiBF₄, LiAsF₆, or combinations thereof. The dielectric constant of the polymer electrolyte may greater than 10 or 20 at 10 k Hz, in some embodiments.

Upon consideration of the subject disclosure, one skilled in the art will readily appreciate that electrochemical cells containing the polymer electrolytes described herein are also contemplated and intended to fall within the scope of the present disclosure.

### BRIEF DESCRIPTION OF THE DRAWINGS

FIG. 1 illustrates sample chemical structures that may be used in the polymer backbone of the disclosed polymer electrolytes, in accordance with various embodiments of the present disclosure.

### DETAILED DESCRIPTION

A polymer electrolyte solvent with a high dipole moiety in the backbone alternating with a low glass transition temperature (T_{g}) moiety is disclosed. The disclosed polymer electrolyte may exhibit numerous advantageous properties. For example, including the high dipole component in the backbone may increase the likelihood of superionic conductivity. Also, the combination of a moiety with a high dipole moment with a moiety to impart low T_{g} may result in a high dielectric constant (>10).

The high dipole moiety of the polymer electrolyte may be any suitable material or combination of materials. In select embodiments, the high dipole moiety is an allyl carbonate, such as diallyl carbonate. In other embodiments, the high dipole moiety is poly(diallyldimethylammonium) bis(trifluoromethanesulfonyl)imide (PDADMA TFSI). In select embodiments, the high dipole moiety may be a quaternary ammonium salt, an organocarbonate (e.g., dimethyl carbonate, ethylene carbonate, or polypropylene carbonate), or combinations thereof. Sample high dipole moieties include one or more of the following polymers:

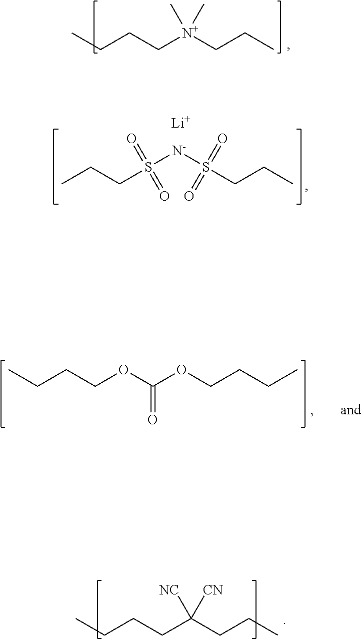

The low T_{g} moiety may be a thiol or another type of material having a relatively low T_{g}. In some embodiments, the low T_{g} moiety may have a T_{g} of less than 120° C., such as less than 100° C., 80° C., 60° C., 40° C., or 20° C. as measured by differential scanning calorimetry (DSC), dynamic mechanical analysis (DMA), and/or thermomechanical analysis (TMA).

In some embodiments, the low T_{g} moiety is 1,4-butanedithiol or 2,2′(Ethylenedioxy)diethanethiol. Sample low T_{g} moieties include one or more of the following polymers:

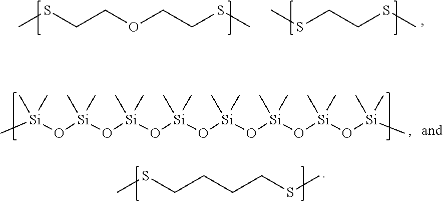

The atomic (molar) ratio of the high dipole moiety and the low T_{g} moiety in the polymer backbone may be between 0.4 and 0.10. In some embodiments, the polymer backbone contains a molar ratio of 0.6 to 0.8 high dipole moiety to low T_{g} moiety.

The polymer backbone may be combined with a salt to form the polymer electrolyte. In some embodiments, the salt may be a lithium salt, such as lithium hexafluorophosphate (LiPF₆), LiClO₄, LiBF₄, LiAsF₆, or combinations thereof.

At 10 k Hz, the dielectric constant of the polymer electrolyte may be greater than 10. In select embodiments, the dielectric constant of the polymer electrolyte may be greater than 20 at 10 k Hz, and in some cases greater than 25 at 10 k Hz.

A few experimental examples are disclosed herein for illustrative purposes.

### EXAMPLE 1

Diallyl Carbonate (a high dipole moeity) undergoes a thiol-ene polymerization with 1,4-butanedithiol (a low T_{g} moeity). The purified polymer is used to dissolve LiTFSI (a salt) to create a polymer electrolyte with an ionic conductivity of 7×10⁻⁵ S/cm.

### EXAMPLE 2

DiallylDimethylammonium TFSI (a high dipole moeity) undergoes a thiol-ene polymerization with 2,2′-(Ethylenedioxy)diethanethiol (a low T_{g} moeity). The purified polymer is used to dissolve LiTFSI (a salt) to create a polymer electrolyte with ionic conductivity of 7×10⁻⁵ S/cm.

### Additional Examples

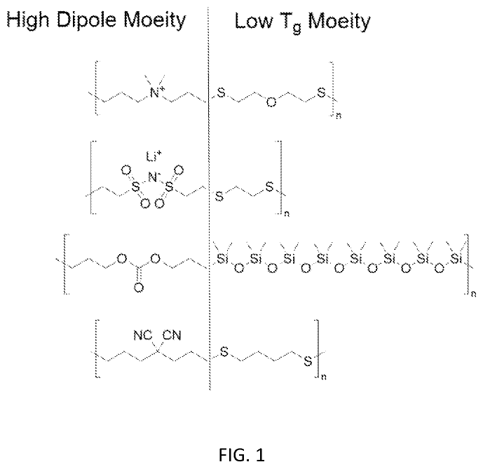

Any of the high dipole moieties and/or low T_{g} moieties shown in FIG. 1 may be used for the disclosed polymer backbone of the disclosed polymer electrolytes, in some embodiments.

What is claimed is:

1. A polymer electrolyte comprising:
a polymer comprising a backbone containing a high dipole moiety and a low T_{g} moiety; and
a salt combined with the polymer.

2. The polymer electrolyte of claim 1, wherein the high dipole moiety is selected from one or more of the following: an allyl carbonate, diallyl carbonate, poly(diallyldimethylammonium) bis(trifluoromethanesulfonyl)imide (PDADMA TFSI), a quaternary ammonium salt, an organocarbonate, dimethyl carbonate, ethylene carbonate, polypropylene carbonate, and combinations thereof.

3. The polymer electrolyte of claim 1, wherein the high dipole moiety is selected from one or more of the following polymers:

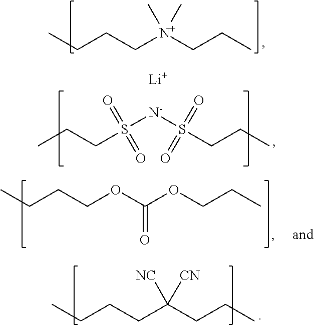

4. The polymer electrolyte of claim 1, wherein the low T_{g} moiety is selected from one or more of the following: a thiol, 1,4-butanedithiol, 2,2′(Ethylenedioxy)diethanethiol, and combinations thereof.

5. The polymer electrolyte of claim 1, wherein the low T_{g} moiety is selected from one or more of the following polymers:

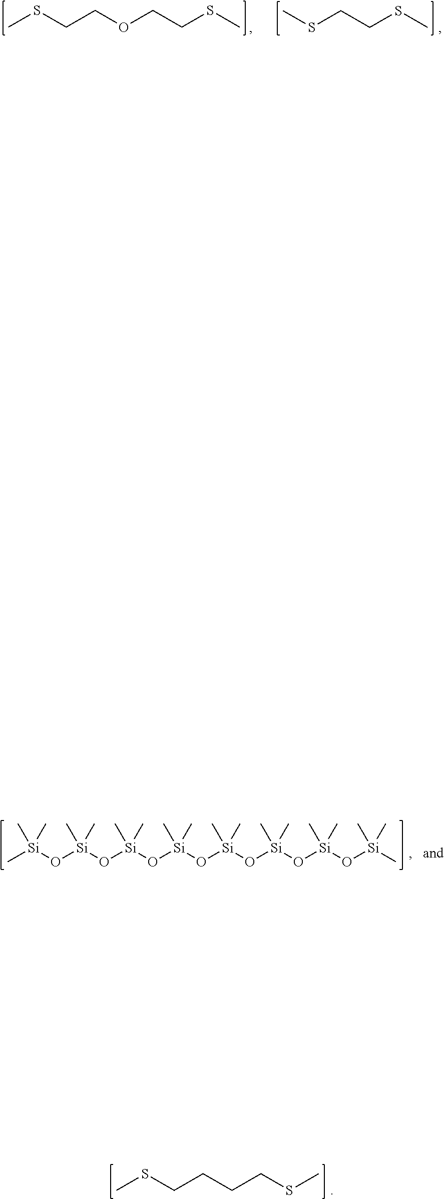

6. The polymer electrolyte of claim 1, wherein the low T_{g} moiety has a T_{g} of less than 120° C.

7. The polymer electrolyte of claim 1, wherein the backbone has a molar ratio of the high dipole moiety and the low T_{g} moiety of between 0.4 and 0.10.

8. The polymer electrolyte of claim 1, wherein the backbone has a molecular weight of greater than 5000 g/mol.

9. The polymer electrolyte of claim 1, wherein the salt is a lithium salt.

10. The polymer electrolyte of claim 9, wherein the lithium salt is lithium hexafluorophosphate (LiPF₆), LiClO₄, LiBF₄, LiAsF₆, or combinations thereof.

11. The polymer electrolyte of claim 1, wherein the dielectric constant of the polymer electrolyte is greater than 10 at 10 k Hz.

12. The polymer electrolyte of claim 1, wherein the dielectric constant of the polymer electrolyte is greater than 20 at 10 k Hz.

13. An electrochemical cell comprising the polymer electrolyte of claim 1.
